(19) United States
(12) Patent Application Publication
(10) Pub. No.: US 2014/0067456 A1
(43) Pub. Date: Mar. 6, 2014

(54) COST MANAGEMENT SYSTEM, COST MANAGEMENT APPARATUS, AND COST MANAGEMENT METHOD

(71) Applicant: Yona KASHIDA, Kanagawa (JP)

(72) Inventor: Yona KASHIDA, Kanagawa (JP)

(73) Assignee: RICOH COMPANY, LTD., Tokyo (JP)

(21) Appl. No.: 13/975,468

(22) Filed: Aug. 26, 2013

(30) Foreign Application Priority Data
Sep. 4, 2012 (JP) 2012-193726

(51) Int. Cl. G06Q 10/06

(52) U.S. Cl. CPC G06Q 10/06315
USPC 705/7.25

(57) ABSTRACT

A cost management system includes a receiving part to receive, via a network, first data from which a cost related to utilization of an apparatus is computed, and second data indicating output information of the apparatus, a computing part to compute the cost based on the first data, and a judging part to judge a bearer of the cost computed by the computing part, based on whether the second data is received by the receiving part.

### CROSS-REFERENCE TO RELATED APPLICATIONS

This application is based upon and claims the benefit of priority of Japanese Patent Application No. 2012-193726, filed on Sep. 4, 2012, the entire contents of which are incorporated herein by reference.

### BACKGROUND OF THE INVENTION

1. Field of the Invention

The present invention generally relates to a cost management system, a cost management apparatus, and a cost management method.

2. Description of the Related Art

Working at home is one style of working. Companies employing this style of working may increase in the future due to developments in communication infrastructure and the like.

When an employee works at home, an apparatus, such as a printer, may be used for private purposes and for work purposes (or official purposes). In this case, the cost related to use of the apparatus needs to be appropriately borne between the company and the employee. That is, the cost related to use of the apparatus for private purposes needs to be borne by the employee, and the cost related to the use of the apparatus for work purposes needs to be borne by the company.

The applicant is aware of Japanese Laid-Open Patent Publication No. 2000-214186.

### SUMMARY OF THE INVENTION

Accordingly, it is a general object in one embodiment of the present invention to provide a novel and useful cost management system, cost management apparatus, and cost management method, in which a bearer of the cost related to use of an apparatus may be distinguished.

According to one aspect of the present invention, a cost management system may include a receiving part configured to receive, via a network, first data from which a cost related to utilization of an apparatus is computed, and second data indicating output information of the apparatus; a computing part configured to compute the cost based on the first data; and a judging part configured to judge a bearer of the cost computed by the computing part, based on whether the second data is received by the receiving part.

Other objects and further features of the present invention will be apparent from the following detailed description when read in conjunction with the accompanying drawings.

### BRIEF DESCRIPTION OF THE DRAWINGS

FIG. 1 is a block diagram illustrating an example of a configuration of a cost management system in a first embodiment;

FIG. 2 is a block diagram illustrating an example of a hardware configuration of a cost computing apparatus in the first embodiment;

FIG. 3 is a diagram illustrating an example of a functional configuration of an information processing terminal and a printing apparatus in the first embodiment;

FIG. 4 is a diagram illustrating a functional configuration of a log collecting apparatus and a cost computing apparatus in the first embodiment;

FIG. 5 is a sequence diagram for explaining an example of a processing procedure of the cost management in the first embodiment;

FIG. 6 is a diagram illustrating an example of a use log;

FIG. 7 is a diagram illustrating an example of a content log;

FIG. 8 is a flow chart for explaining an example of a processing procedure of a cost bearer judging process;

FIG. 9 is a diagram illustrating an example of a configuration of a cost coefficient storing part;

FIG. 10 is a sequence diagram for explaining an example of a processing procedure of the cost management in a second embodiment;

FIG. 11 is a diagram illustrating an example of a functional configuration of the information processing terminal and the printing apparatus in a third embodiment;

FIG. 12 is a block diagram illustrating a configuration of the cost management system in a fourth embodiment; and

FIG. 13 is a block diagram illustrating a configuration of the cost management system in a fifth embodiment.

### DESCRIPTION OF THE PREFERRED EMBODIMENTS

A description will be given of embodiments of the cost management system, the cost management apparatus, and the cost management method according to the present invention, by referring to the drawings.

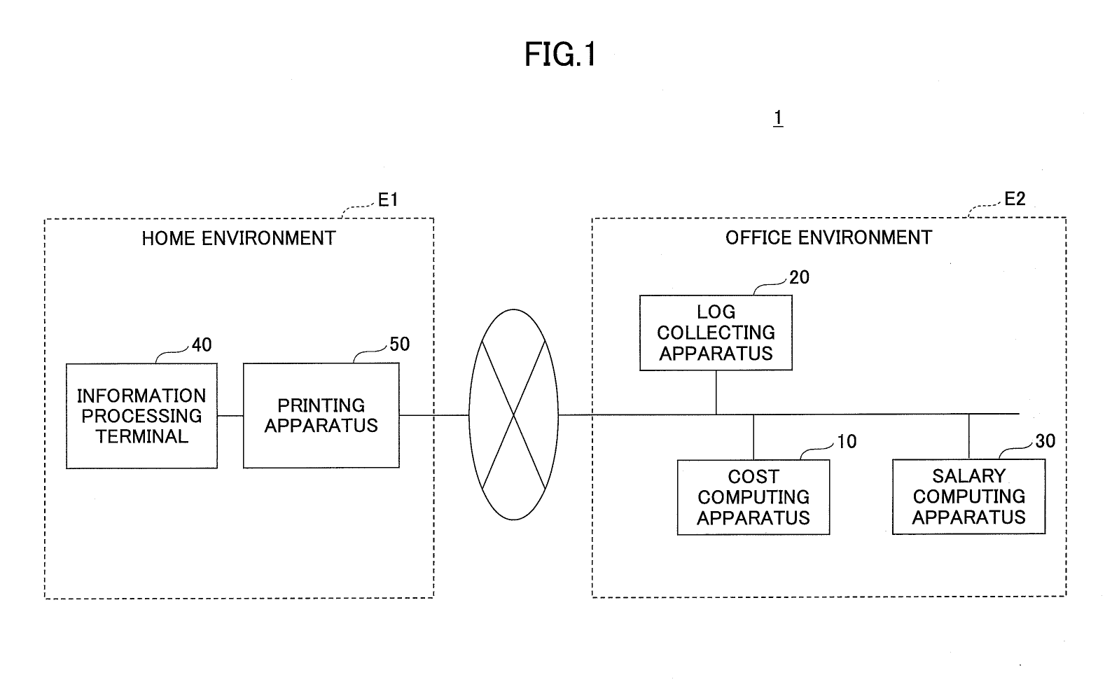

FIG. 1 is a block diagram illustrating an example of a configuration of a cost management system in a first embodiment.

In a cost management system 1 illustrated in FIG. 1, a home environment E1 is a system environment of an employee who works at home, at the home of this employee. On the other hand, an office environment E2 is a system environment of this employee, at an office of a company, employer, or the like (hereinafter simply referred to as the “company”) who employs this employee. The home environment E1 and the office environment E2 may be communicably connected via a network, such as the Internet, for example.

The home environment E1 may include an information processing terminal 40 and a printing apparatus 50. The information processing terminal 40 may be a PC (Personal Computer), a mobile phone, a smart phone, a tablet type terminal, or the like that is used by the employee for private purposes or for work purposes (or official purposes).

The printing apparatus 50 may be a printer that is used by the employee for private purposes or for work purposes. The printing apparatus 50 may transfer log data for each print job to a log collecting apparatus 20. A transfer timing of the log data need not necessarily be the timing at which the print job is executed. For example, the log data may be transferred periodically in a batch, such as once a day, for example.

The office environment E2 may include the log collecting apparatus 20, a cost computing apparatus 10, and a salary computing apparatus 30. The log collecting apparatus 20 may be a computer that receives the log data transferred from the printing apparatus 50 and stores the received log data. In this embodiment, two kinds of log data, namely, use log data (or data of log related to amount of use) and content log data (or data of log related to content), may be transferred from the printing apparatus 50. The use log data may include information that is used to compute a printing cost. The content log data may include information indicating output information of the printing apparatus 50. In the case of the printing apparatus 50, the output information is an image. Accordingly, the content log may include image data indicating a printing content. However, the content log is not transferred with respect to the print job for private purposes.

The use log and the content log related to the same print job may include common identification information. The corresponding relationship of the use log and the content log may be retained using the identification information. In this embodiment, a job ID of the print job may be utilized as the identification information. However, ID information other than the job ID may be utilized as the identification information.

The cost computing apparatus 10 may be a computer that computes the cost (hereinafter also referred to as the “printing cost”) related to each print job. The salary computing apparatus 30 may be computer that computes the salary of the employee, so that the printing cost related to the print job for private purposes is borne by the employee, and the printing cost related to the print job for work purposes is borne by the company. The method of reflecting the printing cost with respect to the salary of the employee may differ depending on a case in which the company leases the printing apparatus 50 to the employee and a case in which the employee owns the printing apparatus 50. In other words, in the case in which the company leases the printing apparatus 50 to the employee, the company bears the initial printing costs, and thus, the printing cost for private purposes may be deducted from the salary of the employee. On the other hand, in the case in which the employee owns the printing apparatus 50, the printing cost for work purposes may be added to the salary of the employee.

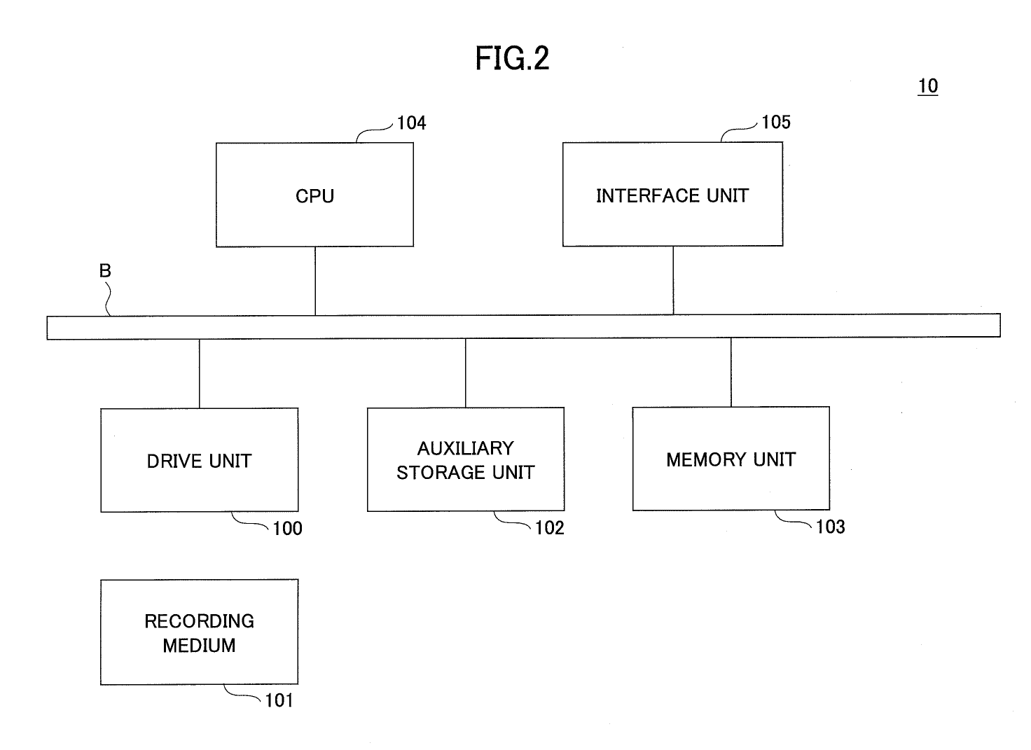

FIG. 2 is a block diagram illustrating an example of a hardware configuration of the cost computing apparatus in the first embodiment. The cost computing apparatus 10 illustrated in FIG. 2 may include a drive unit 100, an auxiliary storage unit 102, a memory unit 103, a CPU (Central Processing Unit) 104, and an interface unit 105 that are mutually connected via a bus B.

A program for causing the CPU 104 to execute a process of the cost computing apparatus 10 may be provided in a form of a recording medium 101, such as a CD-ROM (Compact Disk-Read Only Memory), for example. When the recording medium 101 that stores the program is set in the drive unit 100, the program stored in the recording medium 101 is installed into the auxiliary storage unit 102 via the drive unit 100. The installing of the program does not necessarily have to be made using the recording medium 101, and for example, the program may be downloaded from another computer (not illustrated) via a network. The auxiliary storage unit 102 may store, in addition to the installed program, various data including files and data required by the process of the cost computing apparatus 10.

The memory unit 103 may read the program from the auxiliary storage unit 102 and store the read program into the memory unit 103, in response to a start (or boot) instruction of the program. The CPU 104 may execute functions related to the cost computing apparatus 10 according to the program stored in the memory unit 103. The interface 105 may be used to connect the cost computing apparatus 10 to the network.

Each of the log collecting apparatus 20 and the salary computing apparatus 30 may have the hardware configuration illustrated in FIG. 2, for example. In addition, each of the printing apparatus 50 and the information processing terminal 40 may also have the hardware configuration illustrated in FIG. 2, for example. The information processing terminal 40 may include a display unit and/or an input device that may provide an interface between the employee and the information processing terminal 40. In addition, the printing apparatus 50 may include a hardware unique to the printing function thereof.

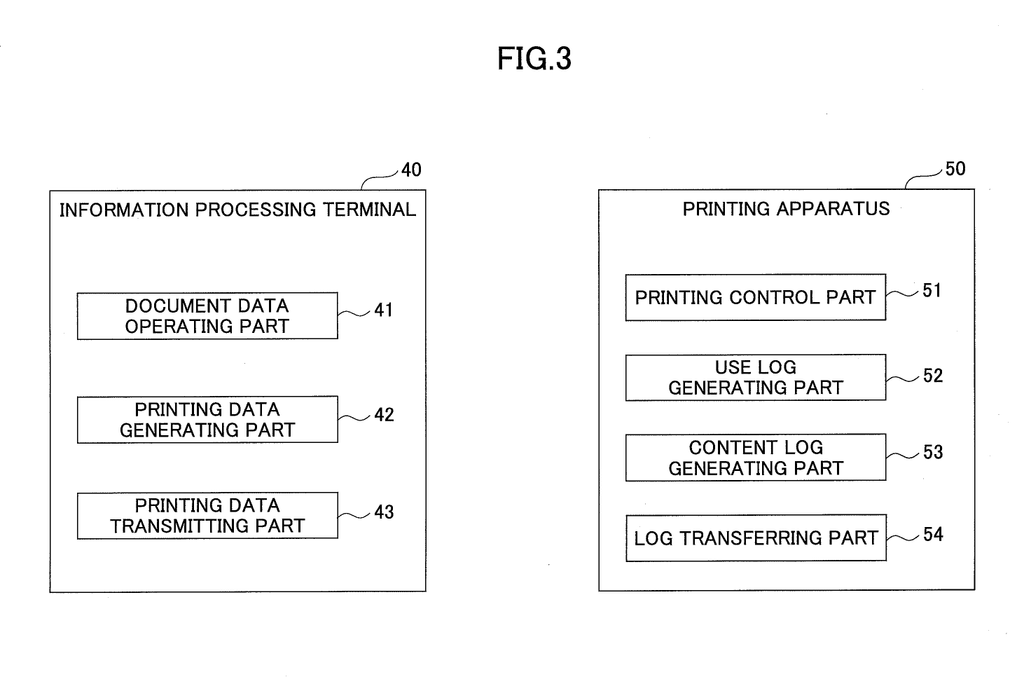

FIG. 3 is a diagram illustrating an example of a functional configuration of the information processing terminal and the printing apparatus in the first embodiment. In FIG. 3, the information processing terminal 40 may include a document operating part 41, a printing data generating part 42, and a printing data transmitting part 43. For example, each of the document operating part 41, the printing data generating part 42, and the printing data transmitting part 43 may be realized by one or more programs installed in the information processing terminal 40. When the installed program or programs are executed by the CPU of the information processing terminal 40, the program or programs cause the CPU to perform the process of each of the document operating part 41, the printing data generating part 42, and the printing data transmitting part 43.

The document data operating part 41 may execute a process to urge the employee (or user) to perform an operation on document data. For example, the document data operating part 41 may be formed by word processing software, spreadsheet software, a Web browser, or the like. The document data may be any electronic data that is a print target, and the content of the document data is not limited to a document. For example, the document data may be image data, data including graphics, or the like.

The printing data generating part 42 may generate printing data with respect to the document data. One printing data generated based on one document data may form one print job. The printing data generating part 42 may be realized by a printer driver, for example. The printing data may have a data format that does not depend from the document data operating part 41, and may be any printing data interpretable by the printing apparatus 50. The printing data may include print setting information. The print setting information may be referred to as a print attribute or a print condition. For example, the print setting information may be a set of setting values with respect to setting items on a print setting screen that is displayed by the printing data generating part 42, such as a paper size, color or monochrome, and printing side. Information indicating whether the printing is for private purposes or for work purposes may be set on the print setting screen, and this information may be included in the printing data as a purpose flag.

The printing data transmitting part 43 may transmit the printing data generated by the printing data generating part 42 to the printing apparatus 50.

On the other hand, the printing apparatus 50 may include a printing control part 51, a use log generating part 52, a content log generating part 53, and a log transferring part 54. For example, each of the printing control part 51, the use log generating part 52, the content log generating part 53, and the log transferring part 54 may be realized by one or more programs installed in the printing apparatus 50. When the installed program or programs are executed by the CPU of the printing apparatus 50, the program or programs cause the CPU to perform the process of each of the printing control part 51, the use log generating part 52, and the content log generating part 53.

The printing control part 51 may control the printing apparatus 50 to output (or print) the image information included in the printing data, in response to receiving the printing data. The use log generating part 52 may generate the use log based on the print setting information included in the printing data. A setting value group with respect to the print setting items related to (or affecting) the printing cost, amongst the print setting information, may form the use log. In addition, the use log may also include identification information (hereinafter also referred to as the “user name”) of the employee who utilizes the printing apparatus 50. The content log generating part 53 may generate the content log based on the image information included in the printing data. The content log generating part 53 may generate the content log only when the purpose flag included in the printing data indicates the work purposes of the printing data. The log transferring part 54 may transfer the use log and the content log to the log collecting apparatus 20. The content log is not transferred to the log collecting apparatus 20 with respect to the printing data (or print job) for which no content log is generated.

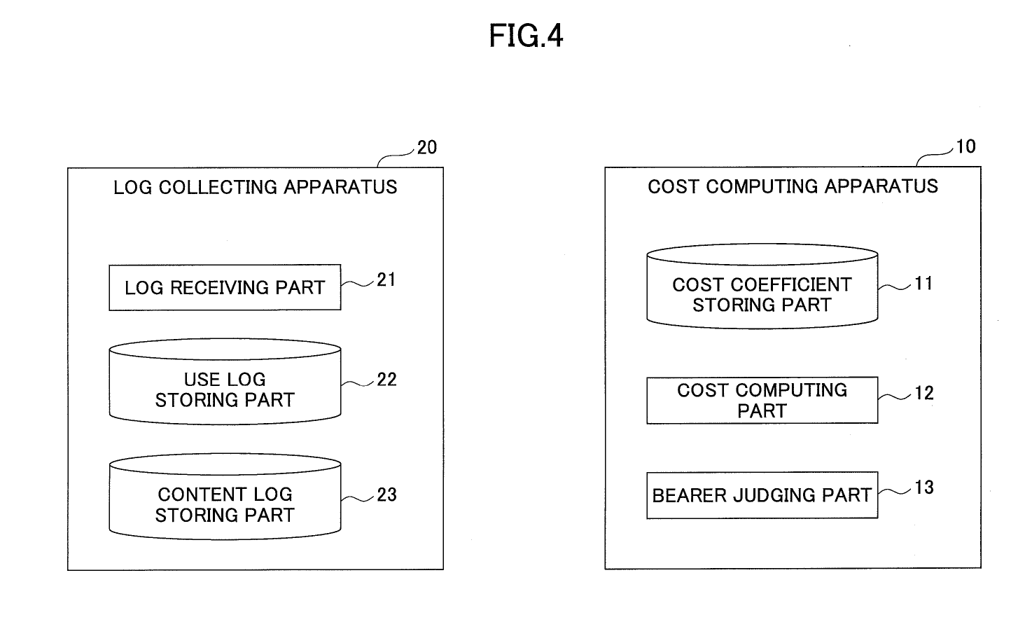

FIG. 4 is a diagram illustrating a functional configuration of the log collecting apparatus and the cost computing apparatus in the first embodiment. In FIG. 4, the log collecting apparatus 20 may include a log receiving part 21, a use log storing part 22, and a content log storing part 23.

The log receiving part 21 may receive the use log and the content log transferred from the printing apparatus 50. The use log storing part 22 may store the received use log. The content log storing part 23 may store the received content log.

For example, the log recording part 21 may be realized by a program installed in the log collecting apparatus 20. When the installed program is executed by the CPU of the log collecting apparatus 20, the program causes the CPU to perform the process of the log recording part 21. For example, the use log storing part 22 and the content log storing part 23 may be realized by use of the auxiliary storage unit or the like of the log collecting apparatus 20.

The cost computing apparatus 10 may include a cost coefficient storing part 11, a cost computing part 12, and a bearer judging part 13. The cost coefficient storing part 11 may store a coefficient with respect to the printing cost per side (or one page) of printing paper, for each of the setting values of the print setting items forming the use log. For example, the cost coefficient storing part 11 may be realized by use of the auxiliary storage unit 102 or the like of the cost computing apparatus 10.

The cost computing part 12 may compute the printing cost of each print job, by referring (or making a reference) to the use log and the cost coefficient storing part 11. The bearer judging part 13 may judge the bearer of the printing cost computed by the cost computing part 12, based on the existence of the content log corresponding to the use log. In a case in which no corresponding content log exists, the bearer judging part 13 may judge that the bearer is the employee having the user name included in the use log. On the other hand, in a case in which the corresponding content log exists, the bearer judging part 13 may judge that the bearer is the company that employs the employee.

Next, a description will be given of a processing procedure executed by the cost management system 1. In this first embodiment, it is assumed for the sake of convenience that the printing apparatus 50 is leased from the company to the employee.

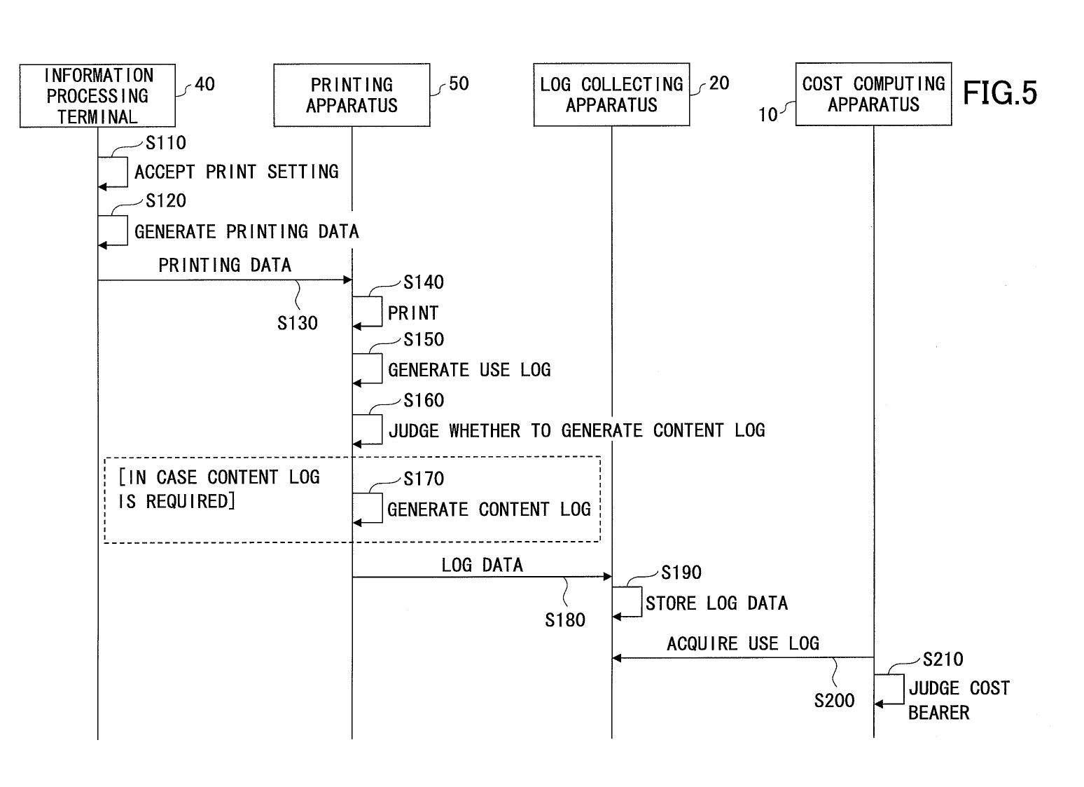

FIG. 5 is a sequence diagram for explaining an example of the processing procedure of the cost management in the first embodiment.

In step S110, the printing data generating part 42 of the information processing terminal 40 may accept input of the print setting information related to the document data that is an operating target on a document operating screen that is displayed by the document data operating part 41. For example, the document operating screen may be a document editing screen of the word processing software. In addition, the print setting information may be input via the print setting screen displayed by the printing data generating part 42 according to an operation on a menu in the document operating screen. The employee may select via the print setting screen whether the print job is for private purposes or for work purposes. For example, a display part to accept the employee's selection may be a check button, a list box, or the like. In any case, in the case in which the printing apparatus 50 is leased from the company to the employee, the print job may be initially selected for the work purposes by a default setting, for example.

Next, when the print instruction is input from the document operating screen, the printing data generating part 42 may generate the printing data with respect to the document data that is the operating target (step S120). The printing data generating part 42 may include, in the printing data, the selection result on the print setting screen on whether the print job is for private purposes or for work purposes, as the purpose flag. The printing data generating part 42 may also include the user name of the employee, the job ID, and the like in the printing data. For example, the user name may be a log-in user name with respect to the information processing terminal 40, and the user name may be input from the print setting screen. For example, the job ID may be automatically assigned by the printing data generating part 42. Next, the printing data transmitting part 43 may transmit the generated printing data to the printing apparatus 50 (step S130).

The printing control part 51 of the printing apparatus 50 may control the printing apparatus 50 to execute the print job based on the received printing data (step S140). Next, the use log generating part 52 may generate the use log related to the executed print job, based on the print setting information included in the printing data (step S150).

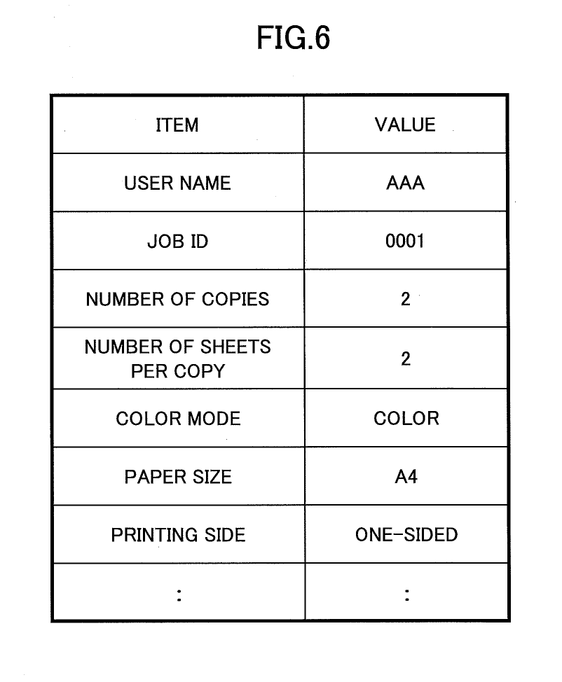

FIG. 6 is a diagram illustrating an example of the use log. The use log illustrated in FIG. 6 may include values for each of the user name, the job ID, the number of copies, the number of sheets per copy, and the setting items of the print setting information. The use log may include other information, such as a printing date and time, and the like.

Next, the content log generating part 53 may judge whether to generate the content log, by referring to the purpose flag included in the received printing data (step S160). In the case in which the value of the purpose flag indicates the printing job for work purposes, the content log generating part 53 may judge that the generation of the content log is required. On the other hand, in the case in which the value of the purpose flag indicates the printing job for private purposes, the content log generating part 53 may judge that the generation of the content log is not required.

In the case in which the generation of the content log is required, the content log generating part 53 may generate the content log related to the printing job, based on the printing data (step S170).

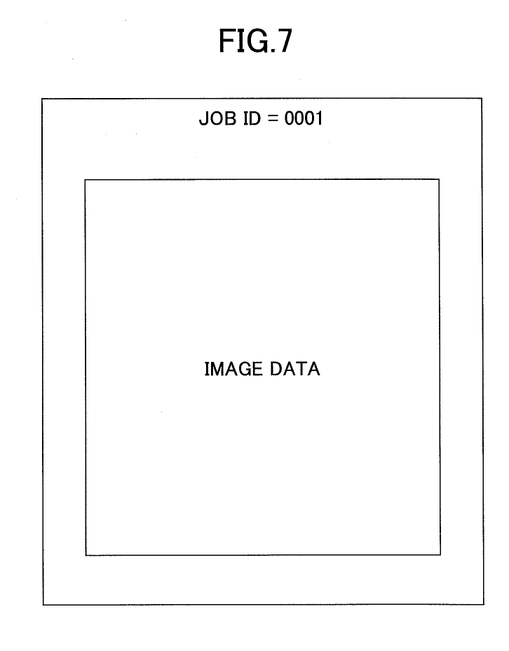

FIG. 7 is a diagram illustrating an example of the content log. The content log illustrated in FIG. 7 may include the job ID, and the image data of the printed image.

Next, the log transferring part 54 may transfer the generated log data to the log collecting apparatus 20 (step S180). The log may include at least the use log. In the case in which the content log is generated, the content log is also included in the log data. For example, address information of a transfer destination of the log data may be prestored in the auxiliary storage unit of the printing apparatus 50. An example of the address information may be an IP (Internet Protocol) address and port number, URL (Uniform Resource Locator), or the like. The use log and the content log need not necessarily be transferred simultaneously.

The log receiving part 21 of the log collecting apparatus 20 may store the received log data in the use log storing part 22 or the content log storing part 23 (step S190). The use log may be stored in the use log storing part 22. The content log may be stored in the content log storing part 23.

Thereafter, at a predetermined timing, the cost computing part 12 of the cost computing apparatus 10 may acquire, from the use log storing part 22, the use log that is not yet acquired (step S200). The use log that is acquired in one acquisition may be one use log, or all of the use logs not yet acquired may be acquired in one acquisition.

Next, the cost computing part 12 and the bearer judging part 13 may execute a cost bearer judging process (step S210).

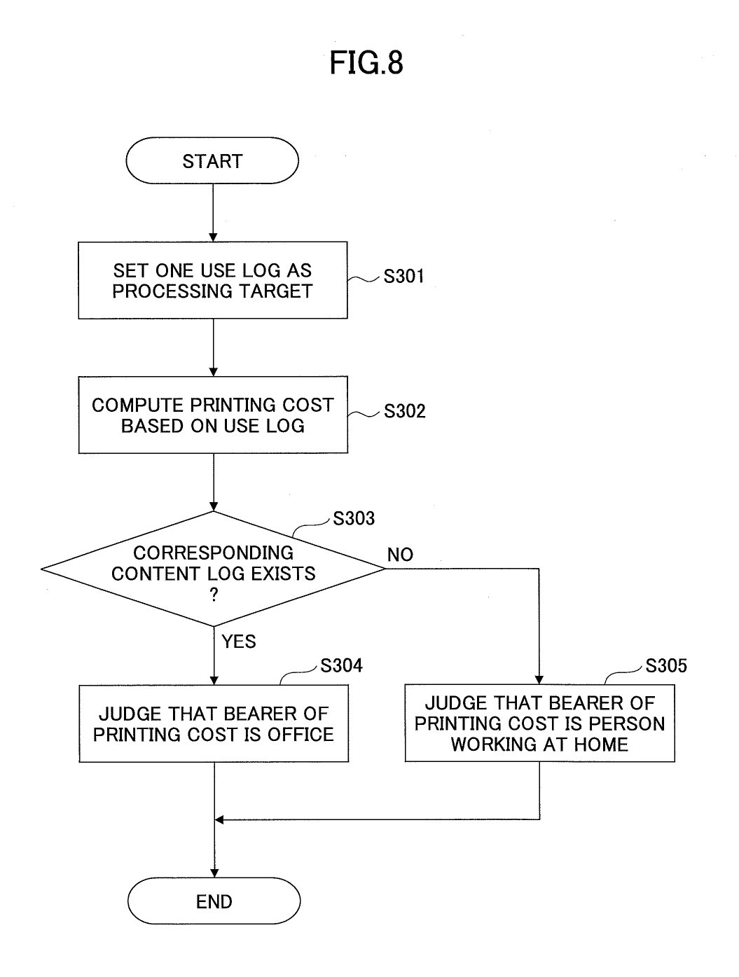

Next, a more detailed description will be given of the cost bearer judging process of step S210. FIG. 8 is a flow chart for explaining an example of a processing procedure of the cost bearer judging process.

In step S301, the cost computing part 12 may set one of the acquired use logs as a processing target. In the following description, the one log that is set as the processing target may also be referred to as the “target use log”.

Next, the cost computing part 12 may compute the printing cost related to the print job in the target use log, based on the target use log (step S302). The cost computing part 12 may refer to the cost coefficient storing part 11 in order to compute the printing cost.

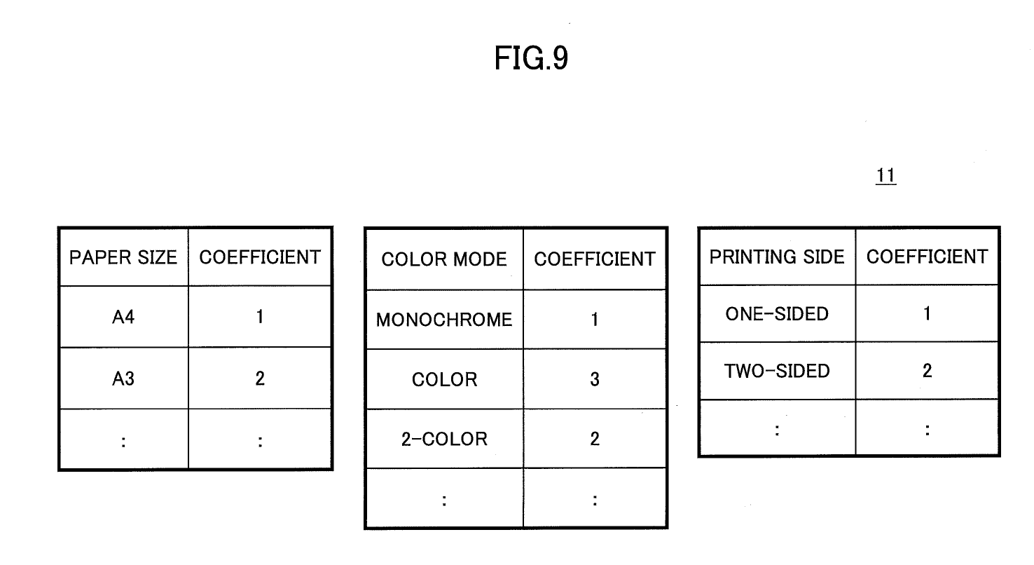

FIG. 9 is a diagram illustrating an example of a configuration of the cost coefficient storing part. FIG. 9 illustrates a table for each setting item of the print setting information. Each table records the coefficient for each value of the print setting information.

For example, if a basic cost per side is 10 Yen, the printing cost may be computed from the following formula.

(printing cost)=10×(number of copies)×(number of sheets per copy)×(coefficient of paper size)×(coefficient of color mode)×(coefficient of printing side) [Yen]

Accordingly, in the case of the use log illustrated in FIG. 6, the printing cost may be computed as follows.

(printing cost)=10×3×2×3×1×1=180 Yen

In this embodiment, only the paper size, the color mode, and the printing side form the print setting items, however, other print setting items may of course be included. In addition, the printing cost may be computed according to other methods.

Next, the bearer judging part 13 may judge whether the content log corresponding to the target use log exists (step S303). More particularly, the bearer judging part 13 may judge whether a content log including a job ID identical to the job ID included in the target use log is stored in the content log storing part 23.

When the corresponding content log exists (YES in step S303), the bearer judging part 13 may judge that the bearer of the printing cost is the company (step S304). On the other hand, when the corresponding content log does not exist (NO in step S303), the bearer judging part 13 may judge that the bearer of the printing cost is the employee whose user name is included in the target use log (step S305).

The judgement result in step S304 or step S305 may be stored in the auxiliary storage unit 102, for example.

The salary computing apparatus 30 may reflect the judgement result stored in the auxiliary storage unit 102 to the salary of the employee. For example, the printing cost for private purposes, whose bearer is the employee, may be deducted from the salary of the employee. On the other hand, the printing cost for work purposes, whose bearer is the company, may be recorded as expenses of the company, for example.

The cost bearer judging process illustrated in FIG. 8 may be executed for each use log acquired in step S200.

As described above, according to this first embodiment, the print job for private purposes and the print job for work purposes may be judged based on the existence of the content log. Thus, the bearer of the printing cost may be distinguished.

Therefore, unauthorized utilization of the printing apparatus 50 by the employee may be presented. In addition, the employee may rightfully utilize the printing apparatus 50 for private purposes.

When the content log is transferred in the case of the print job for private purposes, psychological pressure may be applied to the employee on utilizing the printing apparatus 50 as if the print job were for work purposes even though the print job is for private purposes. In other words, the company may, at any time, confirm the printing content from the content log. For this reason, it may be possible to suppress false reports from being made by the employee on the utilization of the printing apparatus 50.

Next, a description will be given of a second embodiment. Only those parts of this second embodiment that are different from the first embodiment will be described. Accordingly, unless otherwise indicated, this second embodiment operates in the same manner as the first embodiment.

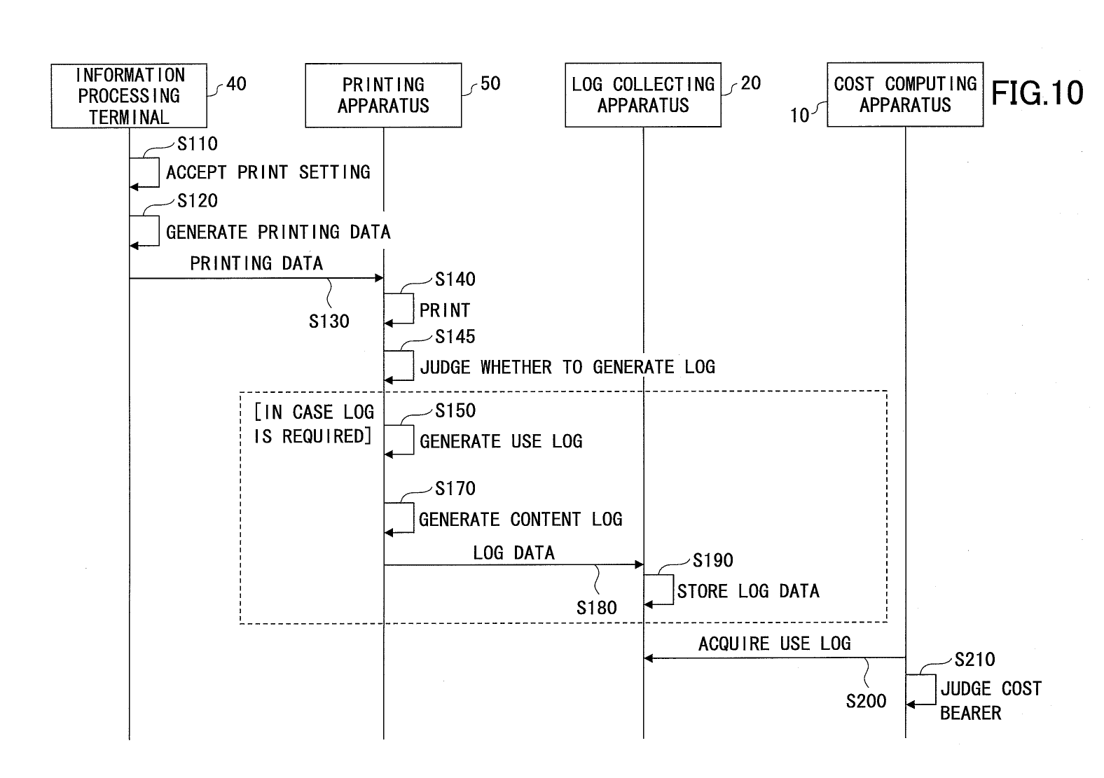

In this second embodiment, it is assumed for the sake of convenience that the employee owns the printing apparatus 50. FIG. 10 is a sequence diagram for explaining an example of a processing procedure of the cost management in the second embodiment. In FIG. 10, those steps that are the same as those corresponding steps in FIG. 5 are designated by the same reference numerals, and a description thereof will be omitted.

In FIG. 10, step S160 is deleted, and step S145 is added. In step S145, the use log generating part 52 may judge whether to generate the log data. The log data may include both the use log and the content log. In other words, step S145 may judge whether to generate each of the use log and the content log. In the case in which the value of the purpose flag included in the print data indicates the print job for work purposes, the use log generating part 52 may judge that the generation of the log data is required. On the other hand, in the case in which the value of the purpose flag included in the print data indicates the print job for private purposes, the use log generating part 52 may judge that the generation of the log data is not required.

Steps S150 through S190 are not executed in the case in which the use log generating part 52 judges that the generation of the log data is not required. In other words, in the case in which the employee owns the printing apparatus 50, the printing cost of the print job for private purposes need not be recorded as expenses of the company, and also need not be reflected to the salary of the employee. Accordingly, in this case, the generation and transfer of not only the use log but also the content log are not performed.

On the other hand, in the case in which the use log generating part 52 judges that the log data is required, the generation and transfer of both the use log and the content log are performed. In other words, in this second embodiment, both the use log and the content log are not generated or transferred for the print job for private purposes, and both the use log and the content log are generated and transferred for the print job for work purposes.

The processing procedure thereafter may be the same as that of the first embodiment. In the processing procedure of this second embodiment illustrated in FIG. 8, the content log corresponding to the target use log basically exists. Hence, except for special cases in which the content log is not transferred due to communication failure or the like, the judgement result in step S303 does not become NO.

In addition, when step S304 judges that the bearer of the printing cost is the company, the salary computing apparatus 30 may add the printing cost to the salary of the employee. In the case in which the employee owns the printing apparatus 50, the employee bears the temporal payment of the printing cost on the company's behalf. Hence, the temporal payment of the printing cost is reimbursed to the employee by adding the printing cost to the salary of the employee.

As described above, this second embodiment may also obtain effects similar to those obtainable in the first embodiment.

Next, a description will be given of a third embodiment. Only those parts of this third embodiment that are different from the first or second embodiment will be described. Accordingly, unless otherwise indicated, this third embodiment operates in the same manner as the first or second embodiment.

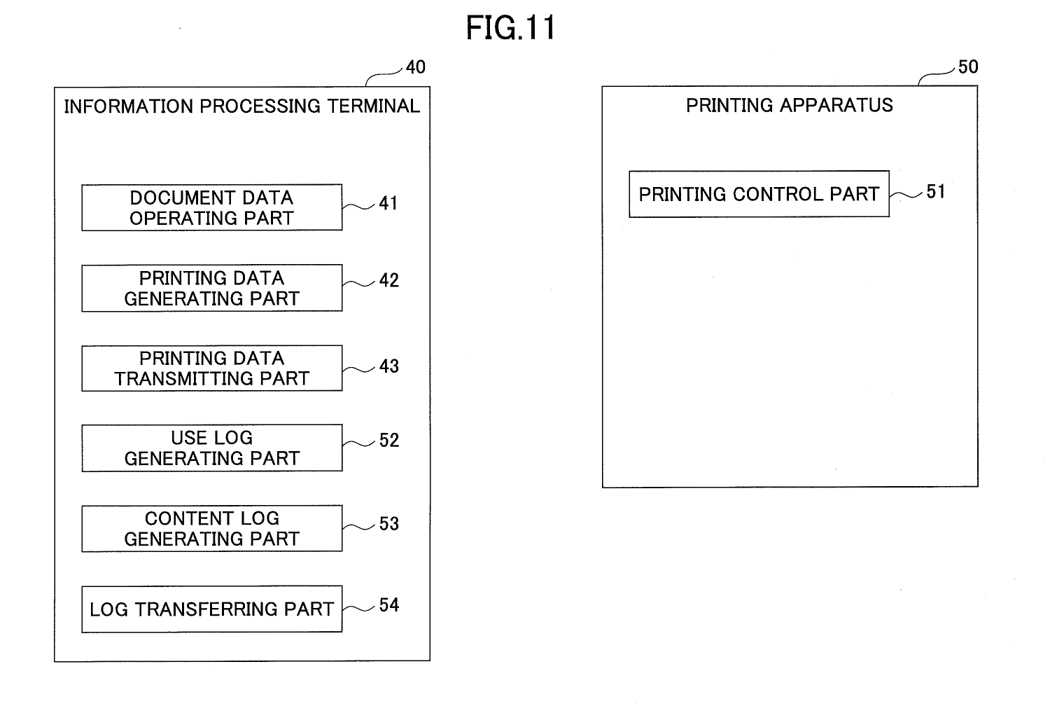

FIG. 11 is a diagram illustrating an example of a functional configuration of the information processing terminal and the printing apparatus in the third embodiment. In FIG. 11, those parts that are the same as those corresponding parts in FIG. 3 are designated by the same reference numerals, and a description thereof will be omitted.

In FIG. 11, the information processing terminal 40 may further include a use log generating part 52, a content log generating part 53, and a log transferring part 54. In other words, in this third embodiment, the use log generating part 52, the content log generating part 53, and the log transferring part 54 may be realized by one or more programs installed in the information processing terminal 40. When the installed program or programs are executed by the CPU of the information processing terminal 40, the program or programs cause the CPU to perform the process of each of the use log generating part 52, the content log generating part 53, and the log transferring part 54.

Accordingly, in this third embodiment, the generation of the use log and the content log, and the transfer of the log data, are executed by the information processing terminal 40. That is, the generation and transfer of the log data does not necessarily need to be executed by the printing apparatus 50.

The processing procedure of this third embodiment may be as described above in conjunction with FIG. 5 or FIG. 10. The processing procedure illustrated in FIG. 5 may be executed in the case in which the printing apparatus 50 is leased from the company to the employee, and the processing procedure illustrated in FIG. 10 may be executed in the case in which the employee owns the printing apparatus 50.

Next, a description will be given of a fourth embodiment. Only those parts of this fourth embodiment that are different from the first, second, or third embodiment will be described. Accordingly, unless otherwise indicated, this fourth embodiment operates in the same manner as the first, second, or third embodiment.

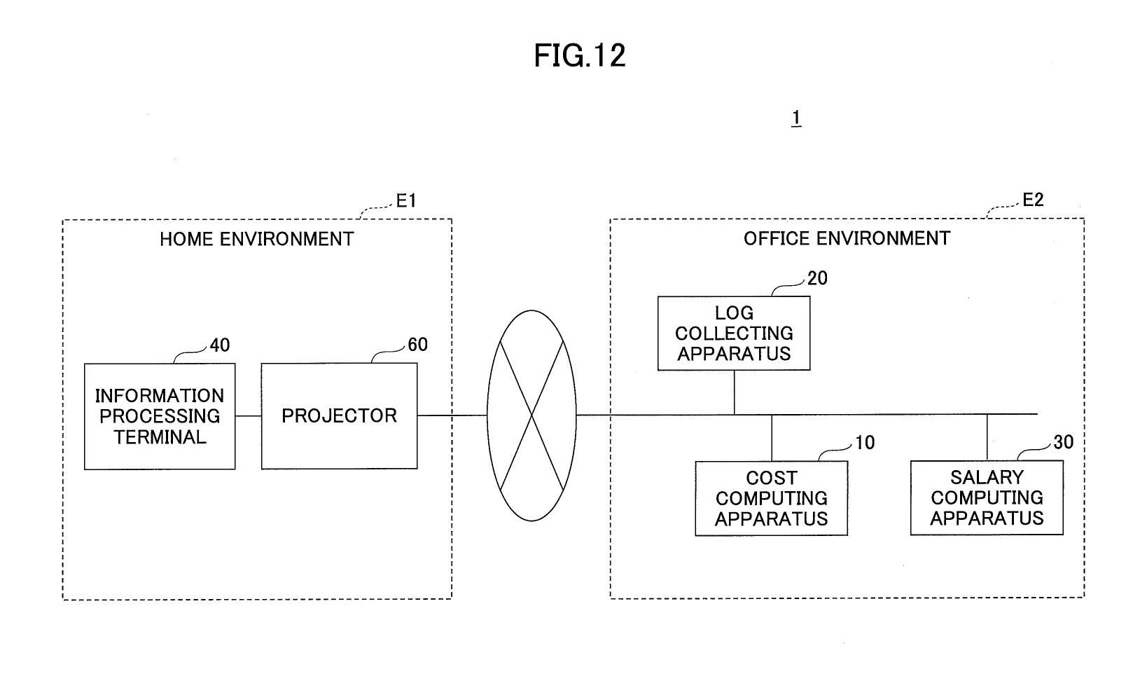

FIG. 12 is a block diagram illustrating a configuration of the cost management system in the fourth embodiment. In FIG. 12, those parts that are the same as those corresponding parts in FIG. 1 are designated by the same reference numerals, and a description thereof will be omitted.

FIG. 12 illustrates an example in which the employee utilizes a projector 60 in the home environment E1. In this case, the use log may include a time when the projector 60 is used, a power consumption of the projector 60, and the like, for example. In addition, the content log may include the image data output (or projected) from the projector 60, or a file storing the projected image data or a file name of the file. In addition, in a case in which the amount of data of the image data is relatively large, a thumbnail image of the image data may be included in the content log.

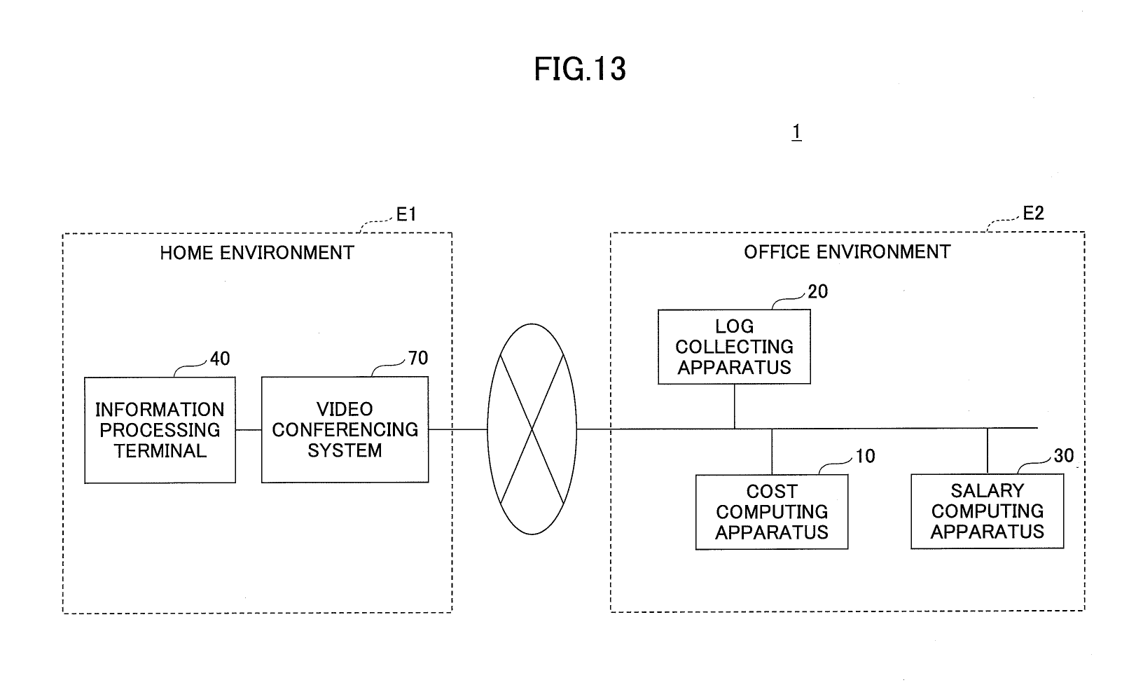

FIG. 13 is a block diagram illustrating a configuration of the cost management system in a fifth embodiment. In FIG. 13, those parts that are the same as those corresponding parts in FIG. 1 are designated by the same reference numerals, and a description thereof will be omitted.

FIG. 13 illustrates an example in which the employee utilizes a video conferencing system 70 in the home environment E1. In this case, the use log may include a time when the video conferencing system 70 is used, a power consumption of the video conferencing system 70, and the like, for example. In addition, the content log may include the address information of other parties participating in the video conference, the image data of the other parties output (or displayed) on the video conferencing system 70 at predetermined intervals, and the like.

The printing apparatus 50 illustrated in FIG. 1 may be a copying machine or a MFP (Multi-Function Peripheral), for example. In addition, other office equipment may be utilized in place of the printing apparatus 50.

In each of the embodiments described above, the log collecting apparatus 20, the cost computing apparatus 10, and the salary computing apparatus 30 may be formed by a single computer. In addition, the log collecting apparatus 20, the cost computing apparatus 10, and the salary computing apparatus 30 may be formed by two or more computers.

Although the embodiments are numbered with, for example, “first,” “second,” “third,” or “fourth,” the ordinal numbers do not imply priorities of the embodiments. Many other variations and modifications will be apparent to those skilled in the art.

Further, the present invention is not limited to these embodiments, but various variations and modifications may be made without departing from the scope of the present invention.

What is claimed is:

1. A cost management system comprising:
a receiving part configured to receive, via a network, first data from which a cost related to utilization of an apparatus is computed, and second data indicating output information of the apparatus;
a computing part configured to compute the cost based on the first data; and
a judging part configured to judge a bearer of the cost computed by the computing part, based on whether the second data is received by the receiving part.

2. The cost management system as claimed in claim 1, wherein the judging part judges that the bearer of the cost is a person utilizing the apparatus in a home environment when the second data is not received by the receiving part, and judges that the bearer of the cost is an employer of the person when the second data is received by the receiving part.

3. The cost management system as claimed in claim 1, wherein the second data indicates an image output from the apparatus.

4. A cost management apparatus comprising:
a storage unit configured to store a program; and
a processor configured to execute the program,
wherein the program which, when executed by the processor, functions as:
a receiving part configured to receive, via a network, first data from which a cost related to utilization of an apparatus is computed, and second data indicating output information of the apparatus;
a computing part configured to compute the cost based on the first data; and
a judging part configured to judge a bearer of the cost computed by the computing part, based on whether the second data is received by the receiving part.

5. The cost management apparatus as claimed in claim 4, wherein the judging part judges that the bearer of the cost is a person utilizing the apparatus in a home environment when the second data is not received by the receiving part, and judges that the bearer of the cost is an employer of the person when the second data is received by the receiving part.

6. The cost management apparatus as claimed in claim 4, wherein the second data indicates an image output from the apparatus.

7. A cost management method to be implemented in a computer, wherein a program which, when executed by the computer, causes the computer to perform a process comprising:
receiving, via a network, first data from which a cost related to utilization of an apparatus is computed, and second data indicating output information of the apparatus;
computing the cost based on the first data; and
judging a bearer of the cost computed by the computing, based on whether the second data is received by the receiving.

8. The cost management method as claimed in claim 7, wherein the judging judges that the bearer of the cost is a person utilizing the apparatus in a home environment when the second data is not received by the receiving, and judges that the bearer of the cost is an employer of the person when the second data is received by the receiving.

9. The cost management method as claimed in claim 7, wherein the second data indicates an image output from the apparatus.
